(19) United States
(12) Patent Application Publication
(10) Pub. No.: US 2025/0017285 A1
(43) Pub. Date: Jan. 16, 2025

(54) DISPLAY FOR AEROSOL-PROVISION DEVICE AND SYSTEM

(71) Applicant: NICOVENTURES TRADING LIMITED, London (GB)

(72) Inventors: Mohammed AL-AMIN, London (GB); Dominic WOODCOCK, London (GB)

(21) Appl. No.: 18/713,430

(22) PCT Filed: Nov. 8, 2022
(86) PCT No.: PCT/GB2022/052819

§ 371 Date: May 24, 2024

(30) Foreign Application Priority Data
Nov. 26, 2021 (GB) 2117068.3

(51) Int. Cl. A24F 40/60

(52) U.S. Cl. CPC A24F 40/60

(57) ABSTRACT

A non-combustible aerosol-provision device is disclosed. It comprises a first display for displaying an image visible to a user on an activated region of the display. The first display is configured such that an inactivated region of the first display is transparent. A non-combustible aerosol-generating system comprising a non-combustible aerosol-generating device according to the invention is also disclosed, together with a method of controlling the non-combustible aerosol-provision device.

### TECHNICAL FIELD

The present specification relates to a non-combustible aerosol-provision device, to a non-combustible aerosol-generating system, and to a method of controlling a non-combustible aerosol-provision device.

### BACKGROUND

Smoking articles, such as cigarettes, cigars and the like burn tobacco during use to create tobacco smoke. Attempts have been made to provide alternative delivery devices to these articles by creating products that release compounds without combustion. Examples of such delivery devices are so-called “heat not burn” products or tobacco heating devices or products, which release compounds by heating, but not burning, a substrate. For example, tobacco heating devices heat an aerosol generating substrate, which may be tobacco or other non-tobacco products which may or may not contain nicotine, to form an aerosol by heating the substrate without burning it.

### SUMMARY

In accordance with some embodiments described herein, there is provided a non-combustible aerosol-provision device comprising a first display for displaying an image visible to a user on an activated region of the display; wherein the first display is configured such that an inactivated region of the first display is transparent.

The non-combustible aerosol-provision device may comprise a housing having an outer surface. The first display may be attached to the outer surface such that said outer surface is visible through the inactivated regions of the first display.

The outer surface of the housing may comprise a contoured shape, and the first display can be configured so that it conforms to the contoured shape of the outer surface of the housing.

The housing may be tubular so that the outer surface extends about a longitudinal axis. The first and/or second displays may extend about the longitudinal axis for at least 90 degrees, at least 180 degrees or 360 degrees, or any other angle therebetween.

The first display may extend in a longitudinal direction for substantially the entire length of the housing.

In another embodiment, the first display forms a housing, i.e. the display and the housing may be integrally formed or the display itself may comprise the housing.

In another embodiment, the non-combustible aerosol-provision device may comprise a second display for displaying an image on activated regions of said second display.

The second display can be located underneath the first display, such that an image displayed on activated regions of the second display is visible through the inactivated regions of the first display.

If the device has a housing with an outer surface, the second display may be located between the outer surface of the housing and the first display.

The housing can comprise a contoured shape. The second display may then be configured to conform to the contoured shape of the housing. In an alternative embodiment, the second display may form the housing of the device.

The housing may be tubular and comprises a curved outer surface extending about a longitudinal axis. The first and/or second display(s) may then extend about the longitudinal axis for at least 90 degrees, at least 180 degrees or 360 degrees, or any other angle therebetween, to provide a curved viewing surface.

The second display can extend in a longitudinal direction for the entire length, or substantially the entire length, of the housing.

The second display may be entirely covered by the first display.

The first display may be mounted to the second display.

The first display may be spaced from the second display.

The non-combustible aerosol-provision device may comprise control circuitry configured to control the first and second displays. The control circuitry may control the first and second displays such that activated regions of the second display are beneath the inactivated regions of the first display, and so that an image displayed on the second display is visible through the inactivated regions of the first display.

The control circuitry can be configured to control the first and second displays such that an image is displayed on the second display and information is displayed on the first display. The information being displayed on the first display can overlay the image on the second display.

The control circuitry can comprise a memory to store images to be displayed on each of the first and second displays.

The control circuitry can comprise a sensor configured to activate the first and/or second display to display an image in response to, for example, user activation of the device, in response to detecting a user in the proximity of the device, and/or in response to movement of the device.

The control circuitry can be configured to display predetermined images on said first and second displays, in dependence on whether the device is being used, or whether a user is in the proximity of the device, or in whether the device is being moved.

The first and/or second display(s) may be configured to display an image comprising at least one of a solid colour, a pattern, an animation or a graphic.

One of the first and second displays may be configured to display a static image, and the other of the first and second displays can be configured to display a moving image.

In any embodiment, the first and second displays can be of the same, or different, types of display.

In some embodiments, the second display can be configured such that inactivated regions of the second display are transparent.

At least one of the first and second displays can be an OLED, flexy TFT, display, OLCD, e-ink (or EPD), AMOLED or PMOLED display.

The first display may be a touch sensitive display. In this case, the first display may be configured to display one or more user selectable elements in response to user input.

According to another aspect, there is provided a non-combustible aerosol-generating device comprising a non-combustible aerosol-generating device according to the invention, and a non-combustible aerosol-generating article receivable in the non-combustible aerosol-generating device.

According to another aspect of the invention, there is provided a method of controlling a non-combustible aerosol-provision device comprising a first display and a second display located beneath the first display, the method comprising displaying an image on an activated region of the first and second displays, respectively, such that an image displayed on an activated region of the second display is visible through an inactivated region of the first display.

### BRIEF DESCRIPTION OF THE DRAWINGS

Embodiments of the invention will now be described, by way of example only, with reference to the accompanying drawings, in which:

FIG. 1 is a perspective view of an example of a non-combustible aerosol-provision device for heating smokable material according to an embodiment of the present invention;

FIG. 2 shows a longitudinal cross-sectional view of the device shown in FIG. 1;

FIG. 3 is a perspective view of an example of a non-combustible device aerosol-provision device for heating smokable material according another embodiment of the present invention; and

FIG. 4 shows a longitudinal cross-sectional view of the device shown in FIG. 3.

### DETAILED DESCRIPTION

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the non-combustible aerosol provision system is an electronic cigarette, also known as a vaping system or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable, such as an article, for use with the non-combustible aerosol provision device. An aerosol-generating material is a material that is capable of generating aerosol, for example when heated, irradiated or energized in any other way. An aerosol-generating material may be in the form of a solid, liquid or gel which may or may not contain an active substance and/or flavourants.

In some embodiments, the non-combustible aerosol provision device may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

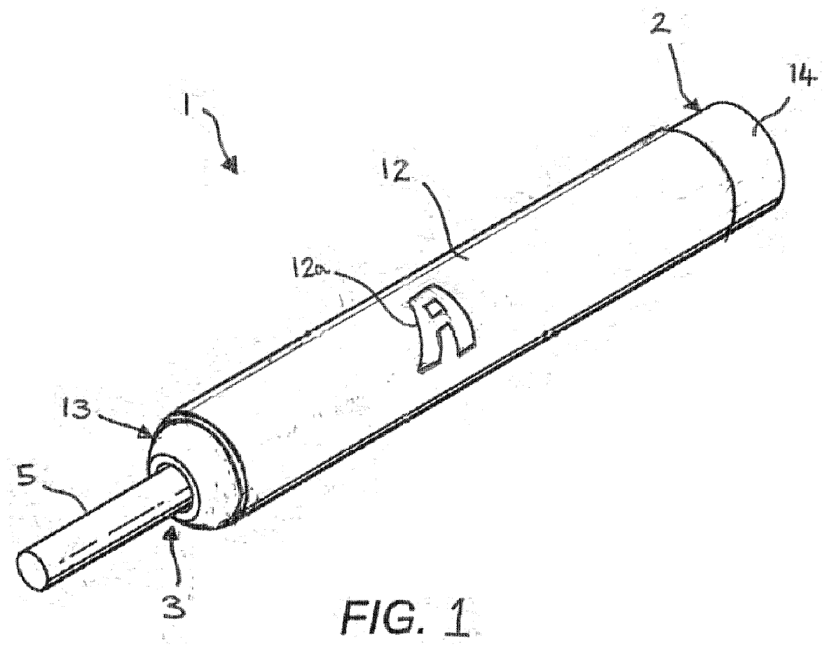

Referring to FIG. 1, there is shown a perspective view of an example of a non-combustible aerosol-provision system comprising a device 1 and an article 5 received in the device 1. The device 1 is arranged to heat smokable material to volatise at least one component of the smokable material for inhalation by a user. The non-combustible aerosol-provision device 1 is a so-called “heat-not-burn” device 1. The device 1 in this example has a generally elongate cylindrical outer housing 2 of circular cross-section. The outer housing 2 has an open end 3, also referred to as the mouth end. The outer housing 2 may be formed of a heat insulating material. A particularly suitable material is polyether ether ketone (PEEK), though other plastics, including for example acrylonitrile butadiene styrene (ABS), or other heat insulating materials, may be used. The outermost surface of the outer housing 2 may have a decorative coating, such as a metallic finish.

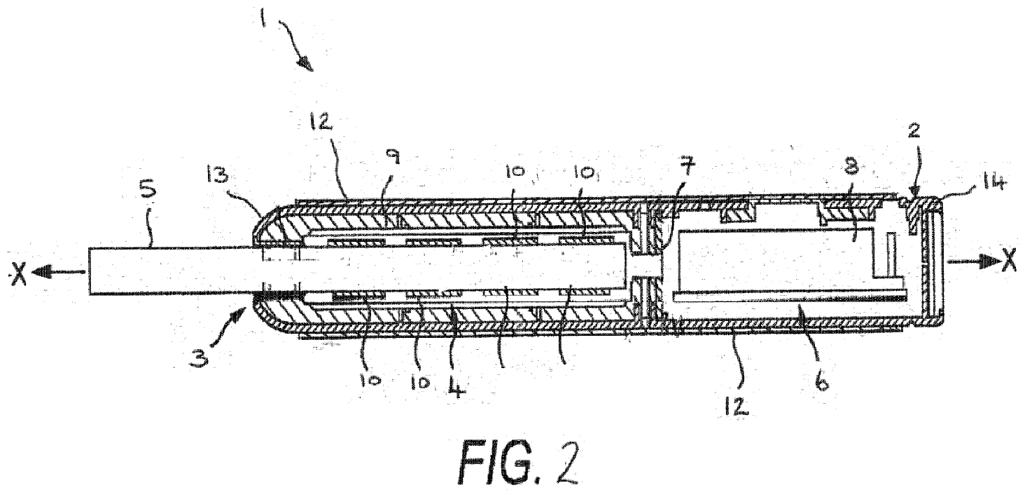

FIG. 2 shows a longitudinal cross-sectional view of the device 1 for heating a smokable material 5, shown in FIG. 1. The system can therefore be considered to be formed of two main components; a device part or aerosol-generating device 1, and a consumable part or aerosol-generating article, generally denoted by smokable material 5. The device part 1 and consumable part 5 are engageable with one another (as shown in FIGS. 1 and 2) such that the consumable part 5 may be engaged with/inserted into the device part 1. The device 1 has a heating chamber 4 which in use contains the smokable material 5 to be heated and volatised. The smokable material 5 may be in the form of a consumable article, which can be removably inserted into the open end 3 of the device 1 by a user. The article 5 may be a generally elongate cylinder, such as a rod. In use, the article 5 is inserted into the housing 2 such that an end of the article 5 projects out of the device 1 through the open end 3 of the housing 2, and such that a user can place their lips over the article 5 in order to inhale an aerosol generated by the device 1.

The device 1 comprises an electronics/power chamber 6 containing electrical control circuitry 7 and a power source 8. In this example, the heating chamber 4 and the electronics/power chamber 6 are adjacent to each other along the longitudinal axis X-X of the device 1. The electrical control circuitry 7 may include a controller, such as a microprocessor arrangement, configured and arranged to control the heating of the smokable material 5, as well as for controlling images appearing on a display or displays that form part of the device 1, as will be described in more detail below.

The electrical control circuitry 7 may in use receive a signal from, for example, a puff-actuated sensor (not shown) which is sensitive to for example changes in pressure or changes in rate of air flow that occur upon initiation of a draw on the smokable material article 5 by a user. The electrical control circuitry 7 can then operate so as to cause heating of the smokable material article 5 “on demand” when required. Various arrangements for a puff-actuated sensor are available, including for example a thermistor, an electro-mechanical device, a mechanical device, an optical device, an opto-mechanical device and a micro electro mechanical systems (MEMS) based sensor. As an alternative, the device 1 may have a manually operable switch for a user to initiate a puff.

The power source 8 may be a battery, which may be a rechargeable battery or a non-rechargeable battery. Examples of suitable batteries include for example a lithium-ion battery, a nickel battery (such as a nickel-cadmium battery), an alkaline battery and/or the like. A particularly preferred type of battery 8 is a LiFePo4 battery. The battery 8 is electrically coupled to the one or more heating elements 10 of the heating chamber 4 to supply electrical power when required and under control of the electrical control circuitry 7 to heat and volatize the smokable material 5 without causing it to burn. In this example, the battery 8 is contained within a printed circuit board of the electrical control circuitry 7. In other examples, the battery 8 and the electrical control circuitry 7 may be arranged differently, such as for example arranged adjacent each other along the longitudinal axis X-X of the device 1.

The heating chamber 4 is contained within a heater support sleeve 9, which is contained within the outer housing 2. In this example, the heater support sleeve 9 is a generally elongate cylinder of circular cross-section. In an example, the heater support sleeve 9 is a double-walled or “vacuum” sleeve, having an outer cylindrical wall and an inner cylindrical wall which are joined to each other at each end.

In one example of the device 1, the heater support sleeve 9 contains plural heating elements or heater segments 10. In this example, the heater segments 10 align along or parallel to the longitudinal axis X-X of the heater support sleeve 9. The electrical control circuitry 7 is configured to supply power to the heater segments 10 to heat the smokable material article 5.

The device 1 in accordance with an embodiment of the present invention shown in FIGS. 1 and 2 comprises a display 12 for displaying an image 12a (represented by the letter “A” in FIG. 1), which is visible to a user on activated regions of the display 12. The display 12 is formed from a transparent, or at least semi- or partially transparent, material such that it is possible to see through inactivated regions of the display 12 to an extent which enables a user to see the surface of the housing 2 beneath the display 12. The display 12 may be entirely clear, or it may be tinted or coloured in some way so that it maintains at least some degree of transparency. Whilst the display 12 is shown proud of the housing 2 in the FIGS. 1 and 2, it will be understood that the display 12 may be recessed into the housing 2, and can be flush with the outer surface of the housing 2 to give the appearance that it is integrally formed with the housing 2. Integration of the display 12 around the device 1, and recessing the display 12 into the surface of the housing 2, may allow the device 1 to have shape similar to a conventional device 1 and so maintain user familiarity.

By “inactivated regions” is meant those regions of the display 12 which are not displaying an image and so are switched off or are inactive. When the device 1 is completely switched off and nothing is being displayed, the entire display 12 may be considered to form an inactive region. When the device 1 is active, and images 12a are being displayed on part of the display 12, the remainder of the display 12 which is not showing an image 12a is considered to be the inactive region or regions. It will be appreciated that there may be a single activated region and a single inactivated region, or their may be multiple activated and inactivated regions.

As shown in FIG. 1, the display 12 may wrap or extend about the housing 2 and so that it closely conforms to the contours of the housing 2. Ideally, the display 12 will at least give the appearance of forming a part of the housing 2, rather than a separate component, even if the display 12 is applied or wrapped about the housing 2 during manufacture. In addition to being transparent, the display 12 may be flexible to enable it to be manipulated so that it assumes or mimics the contours of the outer surface of the housing 2 during manufacture and assembly.

As inactivated regions of the display 12 are transparent, the outer surface of the housing 2 is visible through the inactivated regions so that a user can see the outermost surface of the housing 2. As indicated above, the outer housing 2 may have a decorative coating or finish, such as a metallic finish, which may be visible to a consumer through the inactivated regions of the display 12. Alternatively, fixed images, graphics or text may be applied to the outer surface of the housing 2, which is visible through the display 12.

The display 12 may extend about the longitudinal axis of the housing 2 for any angle. However, the display preferably extends about the housing 2 for at least 90 degrees, at least 180 degrees or 360 degrees, as shown in FIG. 1. The display 12 may also extend in a longitudinal (X-X) direction for the entire, or substantially the entire, length of the housing 2 so that the housing 2 is completely covered, or at least a major portion of the housing 2 is covered, by the display 12. However, there may be areas that are not covered by the display 12, such as a mouthpiece, or an on/off button. In FIGS. 1 and 2, substantially the entire length of the device 1 is covered by the display 12, only short sections 13, 14 of the housing remaining uncovered by the display 12 at opposite ends of the device 1.

In certain circumstances, the display 12 may be resiliently flexible such that a mechanical or pressure sensitive button, i.e. an on/off button, located beneath the display 12 may be activated by applying pressure to the display 12 to temporarily deform the display 12 and, in turn, apply pressure to the button to activate it. Graphics or other images or indicia may appear on the display 12 to indicate to the user the location and/or status of the button located beneath the display 12. The graphics or images may change once the button has been activated. The display 12 may be a flexible display 12 to facilitate formation of the curved viewing surface. In particular, the flexible display 12 may be flexed to provide the curved viewing surface. Once the display 12 is fixed or otherwise coupled to the housing 2, the display 12 may no longer be capable of flexing, for example, when the display 12 is at least partially or entirely attached to the housing 2.

In another embodiment, the display 12 forms an integral part of the housing 2, i.e. the display 12 and the housing 2 are a single integrated component such that the display 12 carries out the dual function of displaying images as well as defining the structural housing containing the components of the device 1, and so the display 12 itself forms the outer surface of the device 1. In this case, the internal components of the device 1, such as the battery 8 and the control circuitry 7, may be directly visible through inactivated regions of the transparent display 12.

The display 12 may be powered by the device battery 8. Alternatively, the display 12 may have its own, separate, power source such as another rechargeable battery (not shown) which is received within the housing 2. The device battery 8 and the display battery may be rechargeable together or independently from each other. The display 12 may be kept ‘on’ by default, only switching off when, for example, power becomes low, or the device 1 hasn't been used for a longer period of time, particularly if a display 12 requiring minimum power is used, such as a e-ink type display.

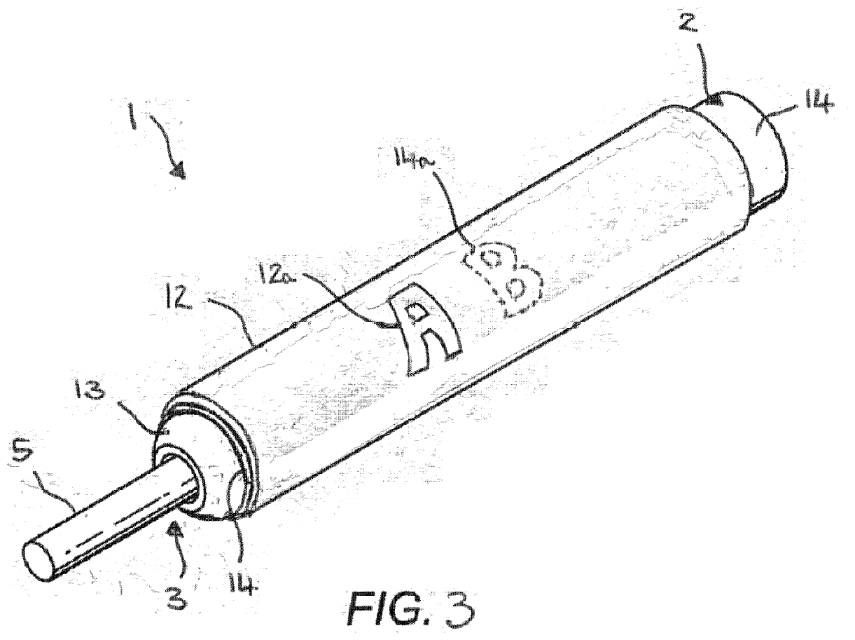

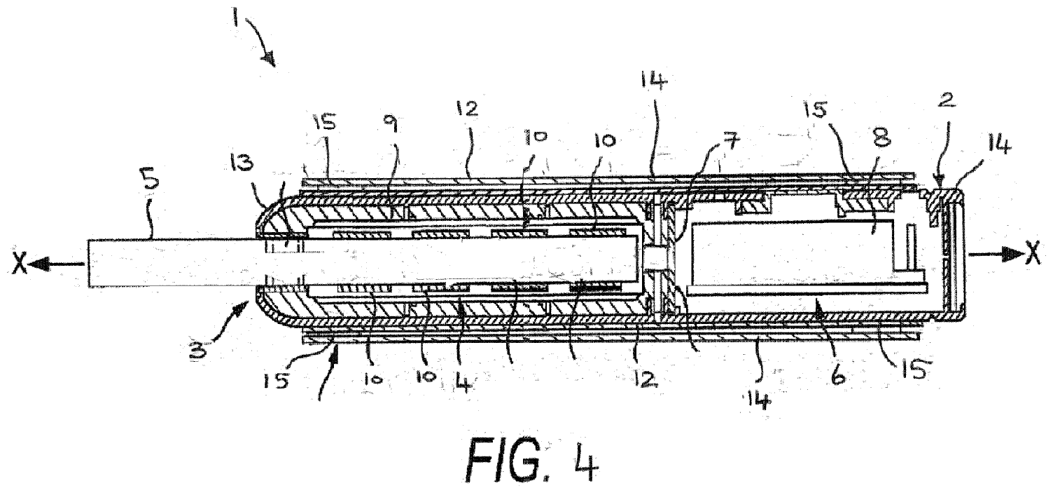

Another embodiment of a non-combustible aerosol-provision device 1 will now be described with reference to FIGS. 3 and 4. In the embodiment of FIGS. 3 and 4, the non-combustible aerosol-provision device 1 comprises two displays, namely a first display 12 similar to that described above with reference to the embodiment of FIGS. 1 and 2, in which the display 12 is wrapped around and extends about the housing 2, and a second, non-transparent, display 14 operable to display images 14a (as represented by image “B”, in dashed lines, and which is visible through the transparent first display 12 in FIG. 3) on activated regions, and which is located between the first display 12 and the housing 2.

In accordance with the two display 12, 14 embodiment, it is the second display 14 which extends about the housing 2 and conforms closely to its contoured outer surface. Alternatively, the second display 14 may form an integral part of the housing 2, as described above in relation to the first display 12. In either case, the first display 12 is then provided so that it extends over the second display 14, and such that an image 14a displayed on activated regions of the second display 14 is visible through the inactivated regions of the first display 12. Although the first and second displays 12, 14 are shown as being proud of the outer surface of the housing 2, it will be understood that either, or both displays, or at least the second display 14, may be recessed into the surface of the housing 2, and the second display 14 or both displays 12, 14 may be flush with the outer surface of the housing 2.

The images 12a, 14a displayed on each of the first and second displays 12, 14 may be controlled via the control circuitry 7 so that there is some interaction between them, i.e. a moving image may initiate on one of the displays 12, 14 and have an association with a different moving image on the other of the two displays 12, 14, to provide an appealing and interesting overall appearance. Alternatively, one of the displays 12, 14 may be used primarily to provide the user with feedback or information relating to the status of the device 1, whereas the other display 12, 14 may be used to show a graphic or image. In a particular embodiment, the second display 14 is used to show a skin, a ‘wallpaper’ to create an overall look to the device 1, whilst the first display 12 is used to provide information to a user which overlays the wallpaper or skin being shown on the second display 14.

As with the first display 12, the second display 14 may extend or wrap about the longitudinal axis (X-X) for at least 90 degrees, at least 180 degrees or 360 degrees to provide a curved and/or contoured viewing surface. The second display 14 may also extend longitudinally (X-X) for at least part of the length, and preferably the entire length, of the housing 2. The first and second displays 12, 14 may be co-extensive so that the second display 14 is entirely covered by the transparent first display 12, or the second display 14 may be smaller than the first display 12 so that the transparent first display 12 extends beyond a periphery of the second display 14, and with that part of the outer surface of the housing 2 surrounding the second display 14, being visible through the larger first display 12.

The first display 12 may be mounted on or attached to, the second display 14. Alternatively, the first display 12 may be mounted to the housing 2 around a periphery of the second display 14 or it may be attached to the housing 2 through openings in the second display 14. Irrespective of how the first and second displays 12, 14 are mounted, the first and second displays 12, 14 may be spaced from each other, so that a user can more clearly perceive the different displays 12, 14 on which an image is being displayed and to give at least an impression of “depth” to the images. Spacers 15 may be provided between the displays 12, 14 to provide the required spacing or gap therebetween.

The control circuitry 7 may be configured to control the first and second displays 12, 14 such that activated regions of the second display 14 are beneath the inactivated regions of the first display 12, so that an image 14a displayed on the second display 14 is visible through the inactivated regions of the first display 12. In some embodiments, the control circuitry 7 may be configured to control the second display 14 to form a “skin” or provide an overall, uniform appearance to the device 1, whereas the first display 12 may be controlled so as to display information to a user, which may appear over the overall appearance being displayed on the second display 14 beneath the information being displayed on the first display 12.

In a modification of the aforementioned embodiment, the second display 14 may also be transparent so that it is possible to see through inactive regions of the display 14. In this case, images can be shown on the first and second displays 12, 14 and a user may be able to see through any overlapping regions of the first and second displays 12, 14 which are not active and see the outer surface of the housing 2 through both displays 12, 14. Therefore, it would be possible to see an image on the first display 12, an image on the second display 14 beneath the first display 12, and the surface of the housing 2, beneath both displays 12. 14. Alternatively, if the second display 14 forms an integral part of the housing 2, it may be possible to see the internal components of the device 1 through both displays 12. 14.

The control circuitry 7 may comprise a memory to store images to be displayed on each of the first and second displays 12, 14, and the device 1 may include a sensor 16 configured to detect an event and to send a signal via the control circuitry 7 to activate the first and/or second display 12, 14 in response to an event occurring. The first and/or second displays 12, 14 may be activated in response to, for example, user activation of the device 1, i.e. when a user presses an on/off button to turn the device 1 on, in response to detecting a user in the proximity of the device 1, and/or in response to movement of the device 1. It is also envisaged that one or both displays 12, 14 may remain active even when the device 1 has not been used for a period of time, and/or even when it has been switched off. The, or each, display 12, 14 may be configured to display a different image depending on the status of the device 1.

The control circuitry 7 may also be configured to so that the first and/or second displays 12, 14 are controlled to display different images in response to a user puffing on the device 1, or in response to a consumable being inserted into the device 1. In each of these cases, various images for each of the two displays 12, 14 may be stored in the memory forming part of the control circuitry 7 of the device. As previously, mentioned the electrical control circuitry 7 may in use receive a signal from for example a puff-actuated sensor to cause heating of the smokable material article 5. The puff-actuated sensor may also generate a signal to control operation of one or both displays 12, 14.

It will be understood that the images displayed by the first and/or any second display 12, 14 may include, comprise or consist of at least one of a solid colour, a pattern, an animation, a graphical representation or any text or other indicia.

In certain embodiments, the control circuitry 7 may be configured to control the first and/or second displays 12, 14 so that one of the displays 12, 14 displays static images, whilst the other displays a moving image. Any suitable static image may be an image displayable on the display 12, 14. The static image may include a cartoon-like image or a realistic image. The static image may be displayed in colour on part of all the display 12, 14.

Any suitable motion image may be an image displayable on the display 12, 14. A motion image may appear as continuous movement or changes in the display 12, 14. For example, brightness or the colour of various pixels may change. The motion image may include a cartoon-like image, a live action image, or a life-like action image (for example, using computer generated graphics).

The first and second displays 12, 14 can be of the same type. However, each of the displays 12, 14 may be of a different type. For example, at least one of the first and second displays 12, 14 can be an OLED, flexy TFT, display, OLCD, e-ink (or EPD), an AMOLED (active-matrix organic light-emitting diode display), or a PMOLED display. The type of display used for each of the first and second displays 12, 14 will depend on the nature of the images to be displayed.

The display or displays 12, 14 may include a plurality of pixels, for example, arranged into an array that are capable of forming images. The display(s) 12, 14 may be used to show various images at different times. The images may be static images or motions images, which may be a series of static images or an encoded motion image. The display(s) 12, 14 may show one or more viewable elements, selectable elements, and colours. The display 12, 14 may be a colour display.

The control circuit 7 of the aerosol-provision device 1 may include one or more of a display driver, a communication interface, a controller (for example, a microprocessor or microcontroller), and a memory to store data. The control circuitry 7 may be operatively coupled to one or more of the display 12, 14, an actuator, an aerosolizer, and the puff sensor to facilitate various functionality of the aerosol-provision device 1.

One or more of the controllers of the control circuitry 7 described herein may include a processor, such as a central processing unit (CPU), computer, logic array, or other system capable of directing data coming into or out of the aerosol-provision device 1. The controller includes one or more computing devices having memory, processing, and communication hardware. The functions of the controller may be performed by hardware and/or as computer instructions on a non-transient computer readable storage medium.

The processor of the controller may include any one or more of a microprocessor, a controller, a microcontroller, a digital signal processor (DSP), an application specific integrated circuit (ASIC), a field-programmable gate array (FPGA), and/or equivalent discrete or integrated logic circuitry. In some examples, the processor may include multiple components, such as any combination of one or more microprocessors, one or more controllers, one or more DSPs, one or more ASICs, and/or one or more FPGAs, as well as other discrete or integrated logic circuitry. The functions attributed to the controller or processor herein may be embodied as software, firmware, hardware, or any combination thereof. While described herein as a processor-based system, an alternative controller could utilize other components such as relays and timers to achieve the desired results, either alone or in combination with a microprocessor-based system.

The exemplary devices, methods, and interfaces may be implemented using one or more computer programs using a computing apparatus, which may include one or more processors and/or memory. Program code and/or logic described herein may be applied to input data/information to perform functionality described herein and generate desired output data/information on each of the displays 12, 14. It will be readily apparent that the controller functionality as described herein may be implemented in any manner known to one skilled in the art.

The control circuitry 7 may be used to enable various modes of the aerosol-generating device 1. One example includes a visual artistic effect on activation mode, in which a motion image may be shown on the display or displays 12, 14, in response to activation of the aerosolizer, for example, by the actuator or puff senor. Upon detecting a puff and optionally receiving a puff profile, the controller may collect a memory address associated with the visual artistic effect to be shown on one or both displays 12, 14. Data associated with the visual artistic effect may be fetched from the memory at the memory address. The data may be used to display or show the visual artistic effect on the first and/or second display 12, 14.

Other image data, such as user information or user messages, may be retrieved in a similar manner, for example, in response to a user action other than puffing. A remote user device (for example, a smartphone or tablet), may be used to detect one or more types of user actions, such as inputs on a touchscreen of the display 12. The visual artistic effect may be displayed concurrently with the activation of the device 1.

Another example of a mode of the aerosol-provision device 1 includes a visual artistic effect as continuous “wallpaper” mode. In this mode, a wallpaper, such as a static or motion image, may be displayed on the second display, beneath the first display 12. Another example includes a user interface mode. This mode may display a user interface image, which may be stored in memory. The user interface image may include one or more selectable elements or viewable elements. User selection of selectable elements using the touchscreen or other buttons may be detected.

The aerosol-provision device according to embodiments, may provide a convenient manner of customisation by allowing downloadable visual and artistic effects to be displayed on one or two overlapping displays 12, 14.

In some embodiments, the first display 12 can be a touch sensitive display, so that it can be used as a communication interface to display one or more user selectable elements in response to user touch. A touch sensitive display 12 on the aerosol-provision device 1 may further increase interaction, reconfigurability, and customization of sensory experiences offered by the aerosol-provision device 1. It is envisaged that graphics or information may be manipulated or moved across the display 12 in response to finger gestures, similar to that achievable using the display of often associated with a smartphone. A user may also be able to activate various functions of the device 1 by using the screen as an input, i.e. by making various gestures on the display 12, such as tapping or swiping. The touch sensitive component may be implemented using any suitable technique, such as capacitive touch sensitivity or resistive touch sensitivity.

It should be appreciated that while the above has focused, in part, on an aerosol-generating device of the “heat-not-burn” type, the principles described herein are not limited to aerosol-generating devices of this type. For instance, one or more displays 12 may be provided on an aerosol-generating devices configured to vaporise a liquid source (which may be achieved by vaporising a small amount of liquid extracted from a liquid reservoir containing a bulk liquid using a liquid transport element or wick). Such aerosol-generating devices are typically referred to as a vaping system or electronic nicotine delivery system (END). Such a system is formed of a device part and a cartridge (which is an example of a consumable part).

The cartridge part comprises a housing (e.g., formed of a plastic material), an aerosol-generating material storage area (or liquid reservoir), an aerosol-generating material transfer component (or wicking element, formed for example of a porous ceramic or bundle of fibres, such as cotton) arranged in fluid communication with the aerosol-generating material storage area, an aerosol generator (which may, for example, include a heating element, such as a resistance heating wire wrapped around the wicking element). The aerosol-generating material transfer component is arranged to provide aerosol-generating material (liquid) to the aerosol generator from the aerosol-generating material storage area. An air/aerosol pathway spans from an inlet of the cartridge to an outlet (which may correspond with a mouthpiece part of the cartridge, which in use, is intended to be inserted into the mouth of a user). The air/aerosol pathway passes alongside/in the vicinity of the aerosol generator, such that vapour generated from the aerosol generator may be entrained in air passing through the air/aerosol pathway in order to be delivered to the user. The area surrounding the aerosol-generator thereby forms an aerosol generation area. The device part comprises suitable components to enable and control the aerosol generation, e.g., such as an electronics/power chamber (similar to electronics/power chamber 6) containing electrical control circuitry (similar to electrical control circuitry 7) and a power source (similar to power source 8). Power may be provided from the device part to the consumable to cause the aerosol generator to generate aerosol (e.g., via passing a current through the aerosol generator via electrical contacts provided on the cartridge that engage with electrical contacts on the device part).

In accordance with the present disclosure, one or more displays may be provided on the device part of the aforementioned vaping system (in a substantially similar manner to that as described above with respect to the “heat-not-burn” device). In addition, or alternatively, the or one or more displays may be provided on the cartridge. The cartridge may be configured to receive an electrical input from the device part to control the one or more displays (if present) on the cartridge. Alternatively, the cartridge may be provided with its own power source and/or controller for controlling the one or more displays (if present) on the cartridge.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. A non-combustible aerosol-provision device comprising:
a first display for displaying an image visible to a user on an activated region of the display;
wherein the first display is configured such that an inactivated region of the first display is transparent.

2. A non-combustible aerosol-provision device according to claim 1, comprising a housing having an outer surface, and wherein the first display is attached to said outer surface such that said outer surface is visible through the inactivated region of the first display.

3. A non-combustible aerosol-provision device according to claim 2, wherein the outer surface of the housing comprises a contoured shape and the first display is configured so that it conforms to the contoured shape of the outer surface of the housing.

4. A non-combustible aerosol-provision device according to claim 3, wherein the housing is tubular and the outer surface extends about a longitudinal axis, the first display extending about the longitudinal axis for at least 90 degrees, at least 180 degrees or 360 degrees.

5. (canceled)

6. A non-combustible device aerosol-provision device according to claim 1, wherein the first display forms a housing.

7. A non-combustible aerosol-provision device according to claim 1, comprising a second display for displaying an image on an activated region of said second display.

8. A non-combustible aerosol-provision device according to claim 7, wherein said second display is located underneath the first display, such that an image displayed on an activated region of the second display is visible through the inactivated region of the first display.

9. A non-combustible aerosol-provision device according to claim 8, comprising a housing having an outer surface, the second display being located between the outer surface of the housing and the first display.

10. A non-combustible aerosol-provision device according to claim 9, wherein the housing comprises a contoured shape and the second display is configured to conform to the contoured shape of the housing.

11. A non-combustible aerosol-provision device according to claim 8, wherein the second display forms a housing.

12. A non-combustible aerosol-provision device according to claim 11, wherein the housing is tubular and comprises a curved outer surface extending about a longitudinal axis, and wherein the first and/or second display extends about the longitudinal axis for at least 90 degrees, at least 180 degrees or 360 degrees to provide a curved viewing surface.

13. (canceled)

14. A non-combustible aerosol-provision device according to claim 8, wherein the second display is entirely covered by the first display.

15. (canceled)

16. A non-combustible aerosol-provision device according to claim 8, wherein the first display is spaced from the second display.

17. A non-combustible aerosol-provision device according to claim 8, comprising control circuitry configured to control the first and second displays such that the activated region of the second display are beneath the inactivated region of the first display, so that an image displayed on the second display is visible through the inactivated region of the first display.

18. A non-combustible aerosol-provision device according to claim 17, wherein the control circuitry is configured to control the first and second displays such that an image is displayed on the second display and information is displayed on the first display, and wherein the information being displayed on the first display overlays the image on the second display.

19. A non-combustible aerosol-provision device according to claim 18, wherein the control circuitry comprises a memory to store images to be displayed on each of the first and second displays.

20. A non-combustible aerosol-provision device according to claim 19, wherein the control circuitry comprises a sensor configured to activate the first and/or second display to display an image in response to user activation of the device, in response to detecting a user in the proximity of the device, and/or in response to movement of the device.

21. A non-combustible aerosol-provision device according to claim 20, wherein the control circuitry is configured to display predetermined images on said first and second displays, in dependence on whether the device is being used, or whether a user is in the proximity of the device, or in whether the device is being moved.

22. (canceled)

23. (canceled)

24. A non-combustible aerosol-provision device according to claim 8, wherein one of the first and second displays is configured to display a static image, and the other of the first and second displays is configured to display a moving image.

25. A method of controlling a non-combustible aerosol-provision device comprising a first display and a second display located beneath the first display,
displaying an image on an activated region of the first and second displays, respectively, such that an image displayed on the activated region of the second display is visible through an inactivated region of the first display.
